(19) United States
(12) Patent Application Publication
(10) Pub. No.: US 2015/0184443 A1
(43) Pub. Date: Jul. 2, 2015

(54) DRIVE APPARATUS

(71) Applicant: AISIN SEIKI KABUSHIKI KAISHA, Kariya-shi (JP)

(72) Inventors: Toshiyuki SAKAI, Kariya-shi (JP); Dai HIDAKA, Kariya-shi (JP); Ryusei SUZUKI, Chiryu-shi (JP)

(73) Assignee: AISIN SEIKI KABUSHIKI KAISHA, Kariya-shi (JP)

(21) Appl. No.: 14/572,880

(22) Filed: Dec. 17, 2014

(30) Foreign Application Priority Data
Dec. 26, 2013 (JP) 2013-269387

(51) Int. Cl. E05F 15/627

(52) U.S. Cl. CPC E05F 15/627; E05Y 2900/532

(57) ABSTRACT

A drive apparatus includes a main body, a movable portion being movable relative to the main body, a first winding portion and a second winding portion each provided at the main body, a third winding portion and a fourth winding portion each provided at the movable portion, a transmission member including a first transmission portion and a second transmission portion, a moving member moving the transmission member, the moving member pulling the first transmission portion and feeding out the second transmission portion, and thereby moving the movable portion relative to the main body and the moving member feeding out the first transmission portion and pulling the second transmission portion, and thereby moving the movable portion relative to the main body.

### CROSS REFERENCE TO RELATED APPLICATIONS

This application is based on and claims priority under 35 U.S.C. §119 to Japanese Patent Application 2013-269387, filed on Dec. 26, 2013, the entire content of which is incorporated herein by reference.

### TECHNICAL FIELD

This disclosure generally relates to a drive apparatus.

### BACKGROUND DISCUSSION

Conventionally, a vehicle is provided with a drive apparatus which operates or moves an operation portion including, a backdoor, a trunk, a side door, a swing door, a slide door, a hood, a window, a seat.

For example, a known drive apparatus is disclosed in JP2007-205102A (which will be hereinafter referred to as Patent reference 1). The drive apparatus disclosed in Patent reference 1 includes an opening assist means which opens a backdoor (a rear door), an opener which opens the backdoor until the backdoor is moved to an opening operation start position at which the opening assist means operates, a closing assist means which closes the backdoor, a drum provided at the backdoor, and a cable of which one end portion is connected to a vehicle body via a pulley provided at the backdoor and of which the other end portion is wound up on the drum. When opening the backdoor, the drum is rotated in a normal direction to wind out the cable, and the opener is operated to open the backdoor to the start position of the opening assist means. Thereafter, the backdoor is opened to a fully-opened state by the opening assist means. When closing the backdoor, the drum is rotated in a reverse direction to wind up the cable, and the backdoor is closed to a closing operation start position of the closing assist means. Thereafter, the backdoor is closed to a fully-closed state by the closing assist means. A gas stay or a torsion spring is used as the opening assist means and the closing assist means.

Another known drive apparatus is disclosed in JP2005-271615A (which will be hereinafter referred to as Patent reference 2). The drive apparatus disclosed in Patent reference 2 includes an arm member of which a base end portion is pivotally connected to a backdoor, a fixed block fixed to a vehicle body, a roller rotatably supported by the fixing block and supporting the arm member in a manner that the arm member is movable, a pulley provided at a distal end portion of the arm member, a drum rotatably provided at the base end portion of the arm member, and a cable which is wound around the pulley and the drum, and of which end portions are fixed to the fixed block. As the drum is rotated in an open direction by an electric motor, the cable between the fixing block and the pulley is wound up around the drum, and the distal end portion of the arm member moves towards the fixing block. Accordingly, an inclination angle of the arm member increases, and thus the backdoor opens. On the other hand, as the drum is rotated in a closing direction by the electric motor, the cable between the fixing block and the drum is wound up on the drum, and the base end portion of the arm member moves towards the fixing block. Accordingly, the inclination angle of the arm member decreases, and thus the backdoor closes.

Another known drive apparatus is disclosed in JP2004-175211A (which will be hereinafter referred to as Patent reference 3). The drive apparatus disclosed in Patent reference 3 includes a drive motor which is rotatable in a normal direction and a reverse direction, a first drum which is rotated by the drive motor, an opening cable of which one end is locked at the first drum and is wound around the first drum, a closing cable of which one end is locked at the first drum and is wound around the first drum in a direction opposite to a direction in which the opening cable is wound around the first drum, a second drum at which the other end of the opening cable and the other end of the closing cable are locked, and around which the opening cable and the closing cable are wound in opposite directions to each other, a link of which one end is fixed to the second drum, and a rod of which one end is rotatably connected to the other end of the link and of which the other end is rotatably connected to the backdoor. When opening the backdoor, the drive motor is rotated in the normal direction, and the opening cable is wound up on the first drum and the closing cable is wound out. Because the opening cable is pulled out, the second drum rotates in a first direction and winds up the closing cable. As the second drum rotates in the first direction, the link rotates and moves the rod, thereby opening the backdoor. On the other hand, when closing the backdoor, the drive motor is rotated in the reverse direction so that the link rotates in a second direction, which is a direction opposite to the first direction, and that the link moves the rod. Consequently, the backdoor closes.

According to the drive apparatus of Patent reference 1, in a case where the backdoor opens/closes, the drum is rotated in the normal direction or the reverse direction to unwind or wind up the cable. However, the backdoor is fully-opened and fully-closed by the opening assist means and the closing assist means, respectively, which correspond to, for example, a gas stay or a torsion spring, but not by the cable. The gas stay and the torsion spring are susceptible to a change in a direction of the vehicle body relative to the direction of gravity on a slope way, or by temperatures. Accordingly, it is difficult to perform an opening/closing control. In a case where the backdoor is in contact with an obstacle during the closing operation, a complicated mechanism is needed for switching from the closing operation to the opening operation.

According to the drive apparatus of Patent reference 2, the arm member is moved by a tensile force of the cable, the inclination angle of the arm member is changed, and thus the backdoor is opened/closed. Accordingly, a thick and robust cable is needed because a large load is applied to the cable. In addition, a large range of movement of the arm member is needed because the arm member moves within the vehicle while pivoting. Accordingly, a large space portion needs to be assured within the vehicle for the drive apparatus of Patent reference 2 to be mounted on the vehicle.

According to the drive apparatus of Patent reference 3, the link is rotated by a tensile force of the cable, and thus the backdoor is opened/closed. Accordingly, a thick and robust cable is needed because a large load is applied to the cable. In addition, the cable needs to be arranged within the vehicle because the cable is wound around the first drum and the second drum which are provided at the vehicle. Accordingly, a large space portion needs to be assured within the vehicle for the drive apparatus of Patent reference 3 to be mounted on the vehicle.

A need thus exists for a drive apparatus which is not susceptible to the drawback mentioned above.

### SUMMARY

According to an aspect of this disclosure, a drive apparatus for moving an operation portion of a vehicle includes a main body, a movable portion being movable relative to the main body, a first winding portion and a second winding portion each provided at the main body; a third winding portion and a fourth winding portion each provided at the movable portion, a transmission member including a first transmission portion wound around the first winding portion and the third winding portion, and a second transmission portion wound around the second winding portion and the fourth winding portion, a moving member moving the transmission member, the moving member pulling the first transmission portion and feeding out the second transmission portion, and thereby moving the movable portion relative to the main body in a manner that the movable portion comes close to the main body; and the moving member feeding out the first transmission portion and pulling the second transmission portion, and thereby moving the movable portion relative to the main body in a manner that the movable portion moves away from the main body.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view illustrating a drive apparatus according to a first embodiment disclosed here in a state where the drive apparatus is provided at a backdoor of a vehicle;

FIG. 2 is a perspective view of the drive apparatus;

FIG. 3 is a perspective view of the drive apparatus in a state where a main body upper cover and a movable portion upper cover are not attached to the drive apparatus;

FIG. 4 is a view illustrating a first end portion of a cable fixed to a first shaft;

FIG. 5A is a view illustrating the drive apparatus in a retracted state;

FIG. 5B is a view illustrating the drive apparatus in an extended or elongated state;

FIG. 6A is a view for explaining the retracted state of the drive apparatus;

FIG. 6B is a view for explaining the extended or elongated state of the drive apparatus;

FIG. 7 is a longitudinal cross-sectional view of the drive apparatus which is taken along line VII-VII in FIG. 5B;

FIG. 8 is a transverse cross-sectional view of the drive apparatus which is taken along line VIII-VIII in FIG. 5B;

FIG. 9A is a view illustrating the drive apparatus in a state where the first end portion and a second end portion of the cable are fixed to a movable portion;

FIG. 9B is a view illustrating the drive apparatus in a state where the first end portion and the second end portion of the cable are fixed to the movable portion;

FIG. 10A is a plan view illustrating a first variation of a cable winding portion;

FIG. 10B is a side view illustrating the first variation of the cable winding portion;

FIG. 11A is a plan view illustrating a second variation of a cable winding portion; and

FIG. 11B is a side view illustrating the second variation of the cable winding portion.

### DETAILED DESCRIPTION

A first embodiment of this disclosure will be described with reference to the drawings. A drive apparatus is provided at a vehicle to operate an operation portion of the vehicle, including, a backdoor of the vehicle, a trunk lid of the vehicle, a side door of the vehicle, a swing door of the vehicle, a slide door of the vehicle, an engine hood of the vehicle, a window of the vehicle and a seat of the vehicle. As an example of the drive apparatus of the first embodiment, an explanation is made on the drive apparatus (a cable type electric extend-and-retract mechanism for a power backdoor) which opens and closes the backdoor serving as an opening/closing body. The use of the drive apparatus, however, is not limited to the opening and closing of the opening/closing body, and the drive apparatus may be used for raising and lowering the seat of the vehicle.

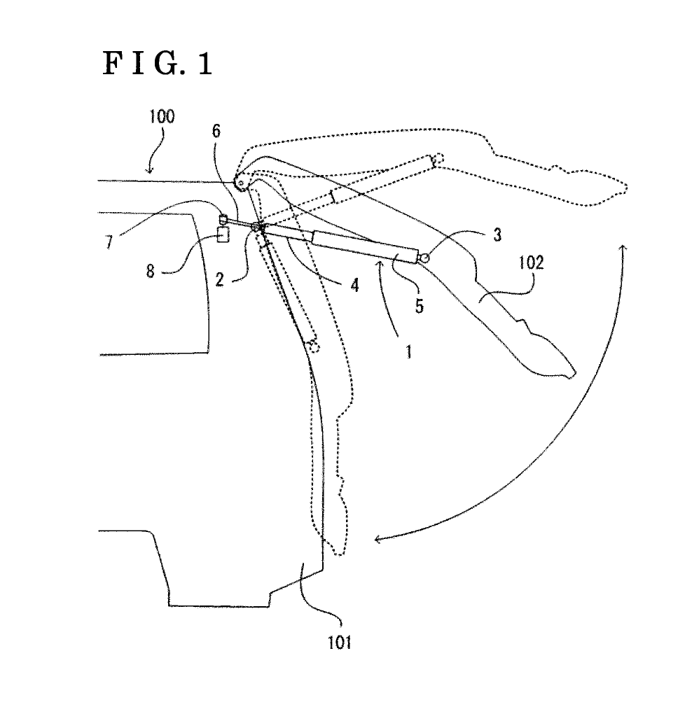

FIG. 1 is a view illustrating a drive apparatus 1 provided at a backdoor (a rear door) 102 of a vehicle 100. The drive apparatus 1 is provided at each side of a vehicle body 101 of the vehicle 100 in a width direction thereof to be positioned between the vehicle body 101 and the flip-up type backdoor 102 (i.e., an operation portion). Joints 2 and 3 are provided at respective end portions of the drive apparatus 1. The joint 2 provided at one end portion of the drive apparatus 1 is connected to the vehicle body 101, The joint 3 provided at the other end portion of the drive apparatus 1 is connected to the backdoor 102. The drive apparatus 1 may be attached to a trough of the vehicle body 101.

The drive apparatus 1 includes a main body 4 and a movable portion 5 which is fitted to the main body 4 in a telescopic manner. The movable portion 5 is movable back and forth (reciprocating motion) linearly relative to the main body 4. The main body 4 and the movable portion 5 form a retractable tube, that is, a tube which can extend and can be retracted. The joint 2 is provided at an end portion of the main body 4. The joint 3 is provided at an end portion of the movable portion 5.

A cable (a power transmission element) 6 is arranged to be extended outwardly from the one end portion of the drive apparatus 1. The cable 6 is wound around a drum 7. The cable 6 may be wound around the drum 7 for plural times so that the cable 6 is engaged at the drum 7 reliably. The drum 7 is configured to be rotated by a motor 8 in a normal direction and a reverse direction. As the drum 7 rotates, one side of the cable 6 is wound up around the drum 7 and the other side of the cable 6 is fed out or supplied from the drum 7. The drum 7 and the motor 8 are provided at the vehicle body 101. A guide groove for guiding the cable 6 may be provided at an outer circumferential surface of the drum 7. The drum 7 and the motor 8 constitute a moving member which moves the cable 6.

In a case where the drum 7 is rotated by the motor 8 in the normal direction, the cable 6 moves, and thus the movable portion 5 moves in a manner that the movable portion 5 moves away from the main body 4, that is, the movable portion 5 moves in a direction in which the movable portion 5 moves away from the main body 4. Accordingly, the drive apparatus 1 extends or is elongated to open the backdoor 102. In a case where the drum 7 is rotated by the motor 8 in the reverse direction, the cable 6 moves, and thus the movable portion 5 moves in a manner that the movable portion 5 comes close to or withdraws to the main body 4, that is, the movable portion 5 moves in a direction in which the movable portion 5 comes close to the main body 4. Accordingly, the drive apparatus 1 is retracted and shortened to close the backdoor 102.

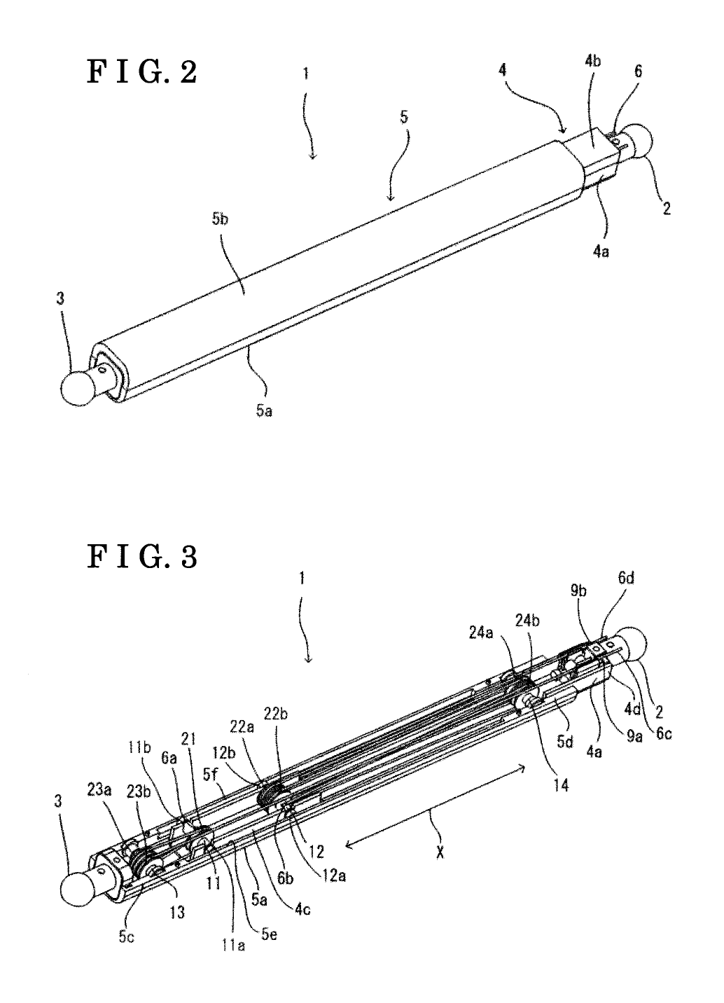

As illustrated in FIG. 2, the main body 4 of the drive apparatus 1 is constituted by a main body case 4a and a main body upper cover 4b. The movable portion 5 of the drive apparatus 1 is constituted by a movable portion case 5a and a movable portion upper cover 5b.

As illustrated in FIG. 3, the main body case 4a is arranged in the movable portion case 5a by insertion. The movable body case 5a is movable back and forth (that is, the movable body case 5a is configured to reciprocate) linearly in a lengthwise direction, which is indicated with an arrow X, of the main body case 4a. That is, the movable portion 5 is movable relative to the main body 4 in a manner that the main body 4 is inserted into the movable portion 5 and that the movable portion 5 protrudes from the main body 4.

A first shaft 11 and a second shaft 12 are provided at a distal end portion 4c of the main body case 4a. The first shaft 11 is provided to be closer to a distal end of the main body case 4a than the second shaft 12. An axis line of each of the first shaft 11 and the second shaft 12 is orthogonal to the lengthwise direction (that is, long-side direction) X of the main body case 4a. The joint 2 is provided at a base portion 4d of the main body case 4a. A third shaft 13 is provided at an end portion 5c of the movable portion case 5a. A fourth shaft 14 is provided at a base portion 5d of the movable portion case 5a. An axis line of each of the third shaft 13 and the fourth shaft 14 is orthogonal to the lengthwise direction X of the main body case 4a. The joint 3 is provided at the end portion 5c of the movable portion case 5a.

End portions 11a, 11b of the first shaft 11 protrude outwardly from the main body case 4a. Similarly thereto, end portions 12a, 12b of the second shaft 12 protrude outwardly from the main body case 4a. Groove holes 5e, 5f are provided at respective sides of an inner wall of the movable portion case 5a to be extended along the lengthwise direction X. The end portion 11a of the first shaft 11 and the end portion 12a of the second shaft 12 are fitted in the groove hole 5e and are engaged therewith. The end portion 11b of the first shaft 11 and the end portion 12b of the second shaft 12 are fitted in the groove hole 5f and are engaged therewith. Each of the groove holes 5e, 5f functions as a guiding portion for the movable portion 5 to move linearly in the lengthwise direction X relative to the main body 4.

A first pulley (sheave) 21 is rotatably supported at the first shaft 11. In the present embodiment, the single first pulley (i.e., a first winding portion) 21 is provided, however, plural first pulleys 21 may be rotatably supported at the first shaft 11 as necessary. Plural second pulleys (sheaves) 22 (22a, 22b) are rotatably supported at the second shaft 12. In the present embodiment, two of the second pulleys (i.e., second winding portions) 22 are provided, however, one second pulley 22, or three or more second pulleys 22 may be rotatably supported at the second shaft 12 as necessary. In the present embodiment, the plural shafts (that is, the first shaft 11 and the second shaft 12) are provided at the main body case 4a, however, a single shaft may be provided at the main body case 4a instead of the first shaft 11 and the second shaft 12. In this case, the first pulley 21 and the second pulleys 22 may be rotatably attached to the single shaft.

Plural third pulleys (sheaves) 23 (23a, 23b) are rotatably supported at the third shaft 13. In the present embodiment, two of the third pulleys (i.e., third winding portions) 23 are provided, however, one third pulley 23, or three or more third pulleys 23 may be rotatably supported at the third shaft 13 as necessary. Plural fourth pulleys (sheaves) 24 (24a, 24b) are rotatably supported at the fourth shaft 14. In the present embodiment, two of the fourth pulleys (i.e., fourth winding portions) 24 are provided, however, one fourth pulley 24, or three or more fourth pulleys 24 may be rotatably supported at the fourth shaft 14 as necessary.

An arrangement of the cable will be described. The cable 6 functions as a transmission member transmitting power from the drum 7 to the movable portion 5. As the transmission member, wire, thread, string and the like may be used instead of the cable. The transmission member may be an elongated and flexible member which is capable of transmitting the power. A first end portion 6a of the cable 6 is fixed to the first shaft 11, The cable 6 is arranged to extend from the first shaft 11 to the third shaft 13 of the movable portion 5 and is wound around the third pulley 23a of the third shaft 13, and then a direction of the cable 6 is changed towards the first shaft 11 of the main body 4. The cable 6 is arranged to extend from the third pulley 23a to the first pulley 21 of the first shaft 11 and is wound around the first pulley 21, and then a direction of the cable 6 is changed towards the third shaft 13 of the movable portion 5. The cable 6 is arranged to extend from the first pulley 21 to the third pulley 23b of the third shaft 13 and is wound around the third pulley 23b, and then a direction of the cable 6 is changed towards the base portion 4d of the main body 4a. The cable 6 is extended outside the drive apparatus 1 through a cable ingress/egress port 9a provided at the base portion 4d. A cable portion that extends from the first end portion 6a of the cable 6 to the cable ingress/egress port 9a corresponds to a first cable portion (i.e., a first transmission portion) 6c.

The cable 6 extended from the cable ingress/egress port 9a is wound around the drum 7 and is arranged to enter a cable ingress/egress port 9b provided at the base end portion 4d of the main body case 4a. The cable 6 is arranged to extend from the cable ingress/egress port 9b to the second shaft 12 of the main body 4 and is wound around the second pulley 22a of the second shaft 12, and then a direction of the cable 6 is changed towards the fourth shaft 14 of the base end portion 5d of the movable portion 5. The cable 6 is arranged to extend from the second pulley 22a to the fourth pulley 24a of the fourth shaft 14 and is wound around the fourth pulley 24a, and then a direction of the cable 6 is changed towards the second shaft 12 of the main body 4. The cable 6 is arranged to extend from the fourth pulley 24a to the second pulley 22b of the second shaft 12 and is wound around the second pulley 22b, and then a direction of the cable 6 is changed towards the fourth shaft 14 of the base end portion 5d of the movable portion 5. The cable 6 is arranged to extend from the second pulley 22b to the fourth pulley 24b of the fourth shaft 14 and is wound around the fourth pulley 24b, and then a direction of the cable 6 is changed towards the second shaft 12. The cable 6 is arranged to extend from the fourth pulley 24b to the second shaft 12 and a second end portion 6b of the cable 6 is fixed to the second shaft 12. A cable portion that extends from the second end portion 6b of the cable 6 to the cable ingress/egress port 9b corresponds to a second cable portion (i.e., a second transmission portion) 6d.

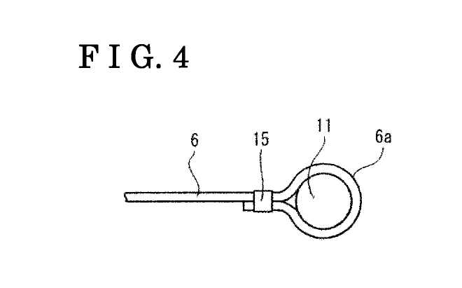

The first end portion 6a of the cable 6 and the second end portion 6b of the cable 6 may be fixed to the first shaft 11 and the second shaft 12, respectively, with a fastening member such as a screw, or by welding. As illustrated in FIG. 4, the first end portion 6a of the cable 6 is formed in an annular shape and is fastened with a fastening member 15. The first shaft 11 may be passed through the first end portion 6a, which is formed in the annular shape, and accordingly the first end portion 6a of the cable 6 may be fixed to the first shaft 11. That is, the first end portion 6a of the cable 6 may move relative to the first shaft 11, however, the first end portion 6a of the cable 6 must not come out of the first shaft 11 in a case where the cable 6 is pulled. The second end portion 6b of the cable 6 may be formed to include a similar shape to the first end portion 6a. The cable 6 does not need to be fixed to the first shaft 11 and the second shaft 12, and the cable 6 may be fixed to the main body 4.

An operation of the drive apparatus will be described below.

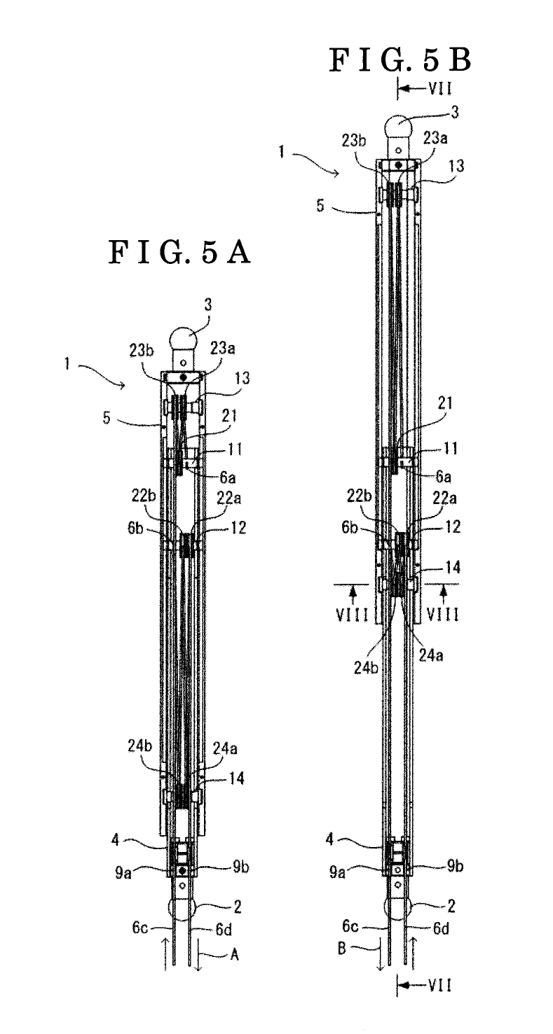

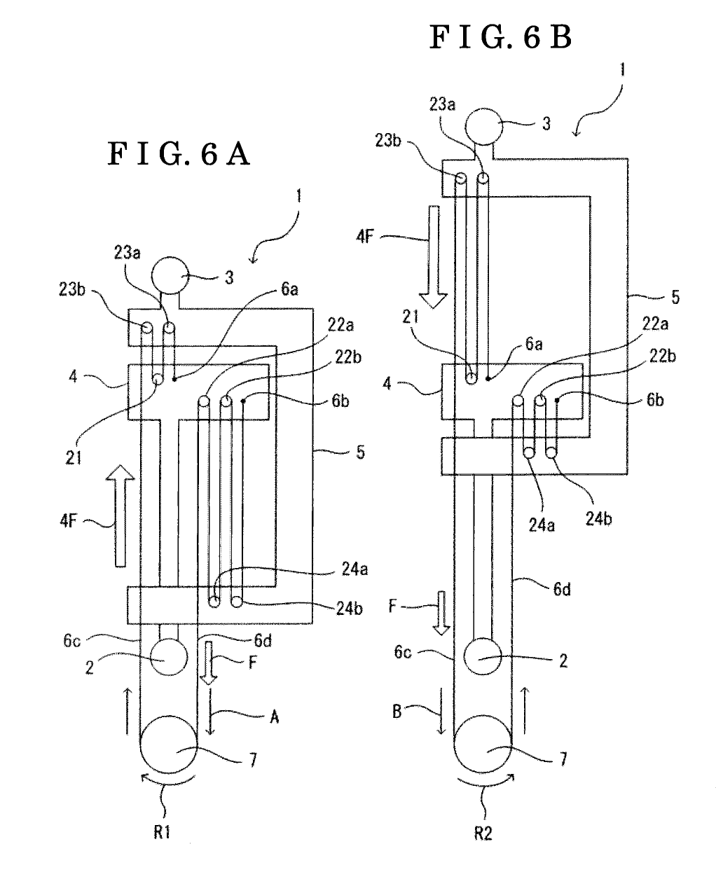

In a case where the drive apparatus 1 is in a retracted or shortened state as illustrated in FIG. 5A and FIG. 6A, the backdoor 102 is in a fully-closed state. In a case where the backdoor 102 opens, the drum 7 is rotated by the motor 8 in the normal direction which is indicated with an arrow R1 in FIG. 6A. The drum 7 pulls the cable 6 from the cable ingress/egress port 9b in a direction indicated with an arrow A. Accordingly, the movable portion 5 moves relative to the main body 4 in a manner that the fourth shaft 14 (the pulleys 24a and 24b) of the movable portion 5 comes closer to the second shaft 12 (the pulleys 22a and 22b) of the main portion 4. At this time, a force with which the drum 7 pulls the cable 6 is a force F, and the movable portion 5 is moved with a force 4F which is four times the force F. The movable portion 5 is pulled with a force that is equivalent to a force with which the movable portion 5 is pulled by four pieces of cable. That is, the force F with which the drum 7 pulls the cable 6 is quadrupled, that is, is boosted to four times, by the action of the pulleys (direction-change portions) 22a, 24a, 22b and 24b. The drive apparatus 1 comes to be in the extended or elongated state as illustrated in each of FIG. 5B and FIG. 68. In other words, the drum 7 and the motor 8 feed out or wind out the first cable portion 6c and pull the second cable portion 6d, and thus the drum 7 and the motor 8 move the movable portion 5 relative to the main body 4 in a manner that the movable portion 5 moves away from or protrudes from the main body 4. At this time, the backdoor 102 is brought to be in a fully-opened state.

In a case where the backdoor 102 closes, the motor 8 rotates the drum 7 in the reverse direction, that is, in a direction which is indicated with an arrow R2 in FIG. 6B. The drum 7 pulls the cable 6 from the cable ingress/egress port 9a in a direction which is indicated with an arrow B in FIG. 6B. Accordingly, the movable portion 5 moves relative to the main body 4 in a manner that the third shaft 13 (the pulleys 23a and 23b) of the movable portion 5 moves towards, that is, moves to be closer to, the first shaft 11 (the pulley 21) of the main body 4. At this time, the force with which the drum 7 pulls the cable 6 is the force F, and the movable portion 5 is moved with the force 4F, which is four times the force F. That is, the force F with which the drum 7 pulls the cable 6 is quadrupled, that is, is boosted to four times, by the action of the pulleys (the direction-change portions) 23b, 21 and 23a. The drive apparatus 1 comes to be in the retracted or shortened state as illustrated in each of FIG. 5A and FIG. 6A. In other words, the drum 7 and the motor 8 pull the first cable portion 6c and feed out the second cable portion 6d, and thus the drum 7 and the motor 8 move the movable portion 5 relative to the main body 4 in a manner that the movable portion 5 moves close to the main body 4 or in a manner that the main body 4 is inserted into the movable portion 5. At this time, the backdoor 102 is brought to be in the fully-closed state.

The direction B (i.e., a first direction) in which the drum 7 pulls the first cable portion 6c is same as the direction A (i.e., a second direction) in which the drum 7 pulls the second cable portion 6d.

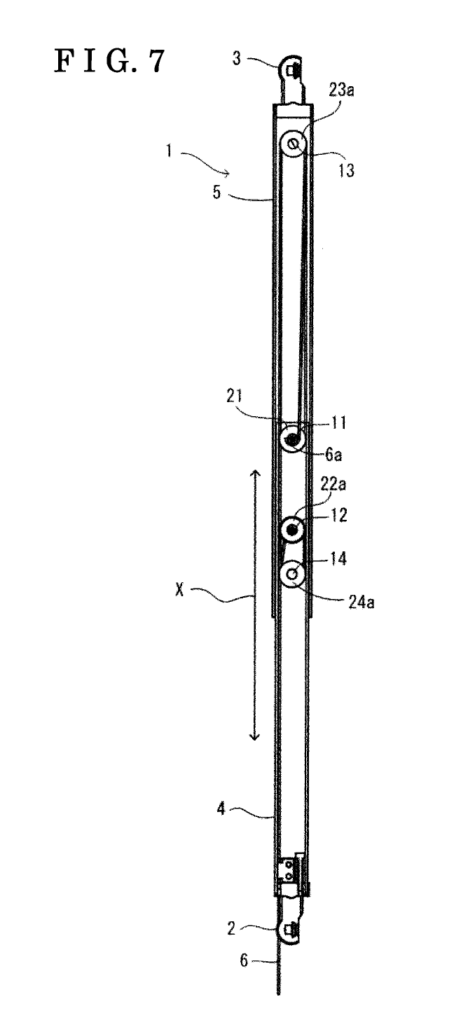

As illustrated in FIG. 7, the first shaft 11, the second shaft 12, the third shaft 13 and the fourth shaft 14 are arranged on a straight line, that is, are arranged linearly with one another, along the lengthwise direction X of the drive apparatus 1. Due to the above-explained arrangement of the first to fourth shafts 11 to 14, the drive apparatus 1 can be formed to be narrow, that is, smaller in a widthwise direction thereof. Accordingly, the drive apparatus 1 may be reduced in dimensions thereof. The first to fourth shafts 11 to 14 do not need to be arranged on the straight line, and the arrangement thereof may be appropriately modified as needed. For example, the first shaft 11 and the second shaft 12 may be arranged side by side in the direction that is orthogonal to the lengthwise direction.

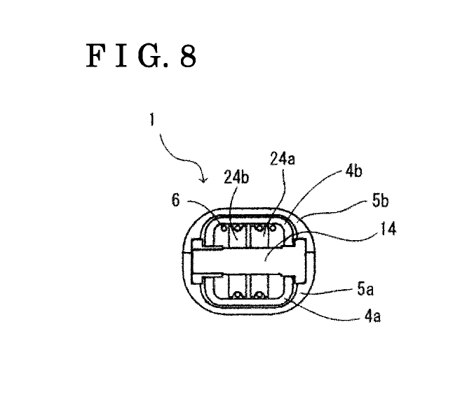

Because the drive apparatus 1 includes a transverse cross section that is substantially rectangular as illustrated in FIG. 8, flexibility in mounting the drive apparatus 1 on the vehicle body 101 is enhanced. The transverse cross section of the drive apparatus 1 is not limited to the rectangular shape, and may be a circular shape or an elliptic or oval shape. By setting the transverse cross section of the drive apparatus 1 to be the rectangular or oval, a cross-sectional area may be reduced compared to a case where the transverse cross section of the drive apparatus 1 is circular.

According to the present embodiment, the motor 8 and the drum 7 may be provided outside the drive apparatus 1, and therefore a ratio of a movement stroke (a stroke) of the movable portion 5 relative to an entire length of the drive apparatus 1 is large. As a result, the drive apparatus 1 of the present embodiment can be mounted on a small vehicle which includes a small space for mounting the drive apparatus.

In addition, operation noise may be reduced because the pulleys 21, 22a, 22b, 23a, 23b, 24a and 24b are used.

In the present embodiment, the first end portion 6a of the cable 6 is fixed to the first shaft 11 of the main body 4 and the second end portion 6b of the cable 6 is fixed to the second shaft 12 of the main body 4, however, this disclosure is not limited thereto. The first end portion 6a and the second end portion 6b of the cable 6 may be fixed to the movable portion 5. Alternatively, the first end portion 6a of the cable 6 may be fixed to the third shaft 13 of the movable portion 5 and the second end portion 6b of the cable 6 may be fixed to the fourth shaft 14 of the movable portion 5.

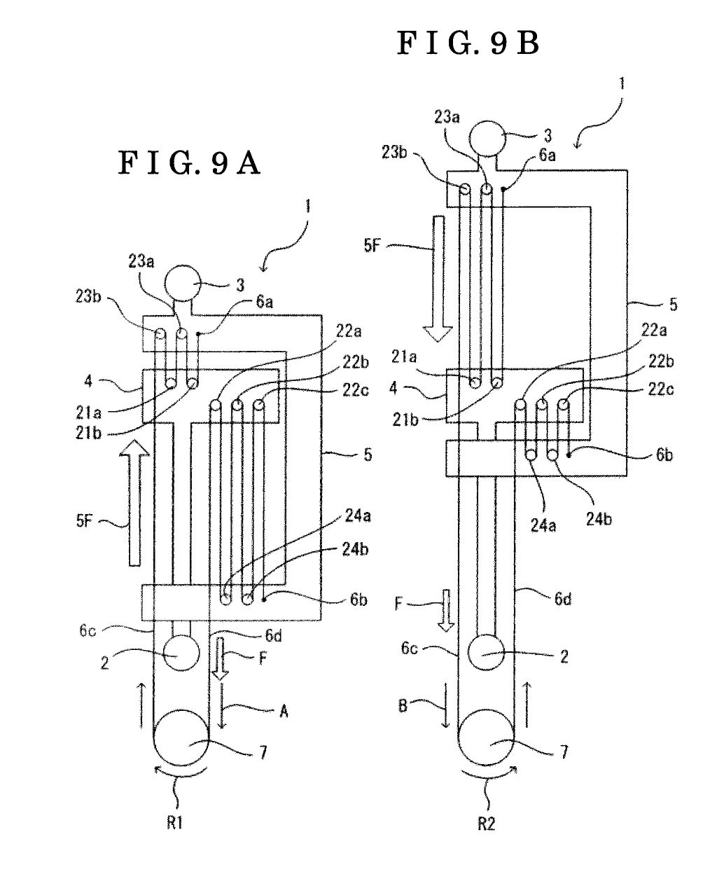

As illustrated in FIG. 9A and FIG. 9B, two pulleys 21a and 21b are provided at the first shaft 11, and thus the first end portion 6a of the cable 6 is fixed to the movable portion 5. In addition, three pulleys 22a, 22b and 22c are provided at the second shaft 12, and thus the second end portion 6b of the cable 6 is fixed to the movable portion 5. The above-explained arrangement of the pulleys also provides effects and advantages that are similar to the aforementioned effects and advantages. Because the number of the pulleys is increased, the movable portion 5 is moved with a force 5F which is five times the force F, with which the drum 7 pulls the cable 6. The movable portion 5 is pulled with a force that is equivalent to a force with which the movable portion 5 is pulled by five pieces of cable.

In a similar manner, the first end portion 6a of the cable 6 may be fixed to the main body 4 and the second end portion 6b of the cable 6 may be fixed to the movable portion 5. Contrary to this, the first end portion 6a of the cable 6 may be fixed to the movable portion 5 and the second end portion 6b of the cable 6 may be fixed to the main body 4.

By appropriately choosing the number of the pulleys (the number of times for which the cable 6 is wound), the force (the boosted force) with which the movable portion 5 is operated or is moved is adjusted. By increasing the number of the pulleys, the force F, that is, a tensile force of the drum 7, is boosted or multiplied to five, six, seven and eight times, for example, and the boosted force is applied to the movable portion 5. Accordingly, the present embodiment may be applied to the backdoor 102 even in a case where the backdoor 102 is heavy.

According to the drive apparatus 1 of the present embodiment, the cable 6 corresponds to the single cable, that is, a single piece of cable, and the first end portion 6a of the cable 6 is fixed to the main body 4 or the movable portion 5, and the second end portion 6b of the cable 6 is fixed to the main body 4 or the movable portion 5. However, plural pieces of cable may be used for the drive apparatus 1. In addition, the plural pieces of cable, of which one end portions are fixed to the main body 4 or the movable portion 5 and of which the other end portions are fixed to the drum 7, may be used for the drive apparatus 1.

A cable winding portion will be described below. In the present embodiment, the pulleys (the sheaves) 21 to 24 serving as the cable winding portions (cable support bodies) are used. The cable winding portion is configured to change the direction of the cable 6 in a state where the cable 6 is wound around the cable winding portion. However, the pulleys may be omitted and the cable 6 may be wound directly around the shafts 11 to 14. In this case, the guide groove for guiding the cable 6 may be provided at each of the shafts 11 to 14. Because the pulleys are not applied, the dimensions of the drive apparatus 1 can be further reduced. In a case where the single shaft which guides the cable 6 is provided at the main body case 4a instead of the first shaft 11 and the second shaft 12, the first winding portion and the second winding portion are formed to be integral with each other.

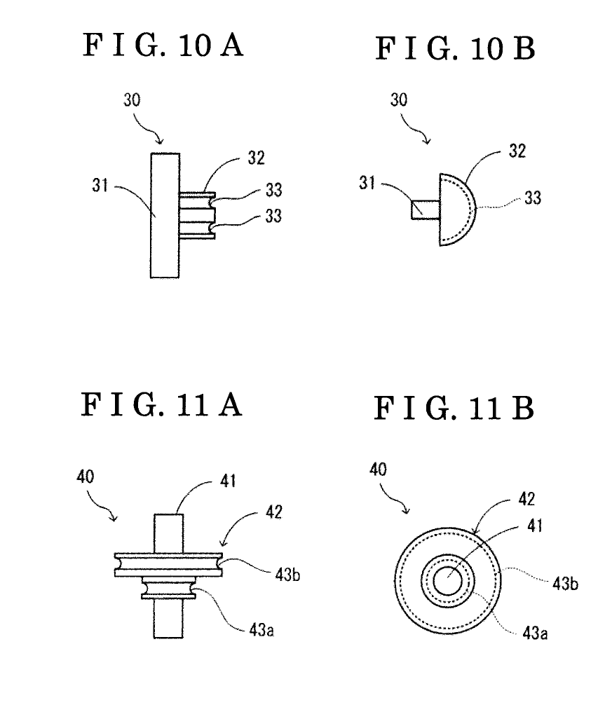

In addition, the pulley or the shaft, which serves as the cable winding portion, includes a circular cross section, however, the cross-sectional shape of the cable winding portion is not limited to the circular shape. A first variation of the cable winding portion will be described below. As illustrated in FIG. 10A and FIG. 10B, a cable winding portion (the cable support body) 30 includes a support portion 31 and a guide portion 32 fixed to the support portion 31. The support portion 31 is fixed to the main body 4 or the movable portion 5, and supports the cable winding portion 30. Plural cable guide grooves 33 are provided at the guide portion 32. The cable guide grooves 33 serve as the direction-change portions which are in contact with the cable 6 and change the direction of the cable 6. Each of the cable guide grooves 33 is formed in a circular-arc configuration, however, the configuration of the cable guide groove 33 |11s not limited thereto. The cable guide grooves 33 may include another configuration which is appropriate for guiding the cable 6. A sliding surface of the cable guide groove 33 with which the cable 6 is in contact may be coated with sliding material so that the cable 6 is prevented from being worn or abraded.

As the cable 6 is pulled by the drum 7, the cable 6 slides on the cable guide grooves 33 and applies a tensile force to the cable winding portion 30. The support portion 31 transmits the force, which is applied to the cable winding portion 30, to the main body 4 or to the movable portion 5. The movable portion 5 is moved by the force applied by the cable 6 to the cable winding portion 30.

According to the present variation, the number of parts and components of the drive apparatus 1 may be reduced because the pulleys are not provided at the drive apparatus 1. In addition, according to the present variation, the drive apparatus 1 which does not fail easily is provided. The drive apparatus 1 may be formed to include a thin shape because the pulleys are not provided thereat.

A second variation of the cable winding portion will be described below. As illustrated in FIG. 11A and FIG. 11B, a cable winding portion 40 serving as a single rotational body is used instead of the plural pulleys (rotational bodies) in the second variation. The cable winding portion (the cable support body) 40 includes a rotational shaft 41 and a guide portion 42 fixed to the rotational shaft 41. The rotational shaft 41 is rotatably supported at the main body 4 or the movable portion 5. The rotational shaft 41 rotates integrally with the guide portion 42. The rotational shaft 41 and the guide portion 42 may be separate portions from each other. The guide portion 42 may be supported at the rotational shaft 41 to rotate relative to the rotational shaft 41.

Plural cable guide grooves 43 (43a, 43b) are provided at the guide portion 42. Each of the cable guide grooves 43 is formed at an outer circumference of the guide portion 42 to include an annular shape. The cable guide grooves 43 serve as the direction-change portions which are in contact with the cable 6 and change the direction of the cable 6. Each of the cable guide grooves 43 is formed in a circular shape. A diameter of the cable guide groove 43a differs from a diameter of the cable guide groove 43b. The diameter of the cable guide groove 43a, which engages with a portion of the cable 6 which is closer to an end portion of the cable 6 fixed to the main body 4 or the movable portion 5, is smaller than the diameter of the cable guide groove 43b, which engages with a portion of the cable 6 which is away from the end portion of the cable 6. This is because, as a position of the cable guide groove 43 becomes closer to the end portion of the cable 6, an amount of movement of the cable 6 becomes smaller accordingly, and therefore a moving speed of the cable 6 becomes slower accordingly. As the position of the cable guide groove 43 becomes farther from the end portion of the cable 6, that is, as the position of the cable guide groove 43 becomes closer to the drum 7, the diameter of the cable guide groove 43 is set to be larger. Approximately, a ratio of the increment in the diameter of the cable guide groove 43 is an even multiple number such as two times, four times or six times, or an odd multiple number such as three times, five times or seven times.

As the cable 6 is pulled by the drum 7, the cable 6 comes to be engaged with the cable guide grooves 43 and causes the cable winding portion 40 to rotate. In addition, the cable 6 applies the tensile force to the cable winding portion 40. The rotational shaft 41 transmits the force, which is applied to the cable winding portion 40, to the main body 4 or to the movable portion 5. The movable portion 5 is moved by the force applied by the cable 6 to the cable winding portion 40.

According to the present variation, the number of parts and components may be reduced.

The cable and the cable winding portions are made of metal. However, the cable may be made of metal and the cable winding portion may be made from resin material so that a sliding performance or slidability of the cable and the cable winding portions is enhanced. Alternatively, the cable may be made from resin material and the cable winding portion may be made of metal. Alternatively, the cable and the cable winding portions are made from resin material.

In addition, to enhance the sliding performance between the cable and the cable winding portions, a surface of the cable or a surface of the cable winding portion may be coated with the sliding material which provides a high slide performance, including, polytetrafluoroethylene.

A position of the motor will be described below. In the present embodiment, the drum 7 and the motor 8 (an actuator) which drive the cable 6 of the drive apparatus 1 are provided at the vehicle body 101 to be separated from the drive apparatus 1. Accordingly, at an opening portion of the vehicle 100 at which the drive apparatus 1 is provided, a region or space which is occupied by the drive apparatus 1 is reduced. Further, the ratio of the movement stroke (the stroke) of the movable portion 5 relative to the entire length of the drive apparatus 1 is increased.

However, the drum 7 and the motor 8 (the actuator) may be provided within the main body 4 of the drive apparatus 1, Alternatively, the drum 7 and the motor 8 may be attached to the main body 4 of the drive apparatus 1 from an outside of the main body 4. In a case where the drum 7 and the motor 8 are incorporated into the drive apparatus 1 as described above, the drive apparatus 1 may be attached to the vehicle body 101 at the joint 2 and the joint 3, that is, only at the two positions, and accordingly the drive apparatus 1 may be attached to the vehicle 101 easily. A storage battery may be provided within the drive apparatus 1 or at the outside of the drive apparatus 1. In a case where the storage battery and a wireless control apparatus are provided within the drive apparatus 1, there is no need to arrange electric wiring between the vehicle body 101 and the drive apparatus 1.

A decelerator may be provided between the motor 8 and the drum 7. The decelerator serves as a holding mechanism which keeps an open position of the backdoor 102.

According to the aforementioned embodiments, the drive apparatus is provided, which includes the simple configuration using the cable and which may be reduced in size.

A direction in which the cable is pulled will be described below. In the aforementioned embodiments, the drum 7 and the motor 8 (i.e., the moving members) are provided in a manner that the first cable portion 6c and the second cable portion 6d are pulled towards the joint 2 of the drive apparatus 1. However, this disclosure is not limited thereto, and the drum 7 and the motor 8 (i.e., the moving members) may be provided in a manner that the first cable portion 6c and the second cable portion 6d are pulled towards the joint 3 of the drive apparatus 1. In this case, the main body 4a corresponds to the movable portion and the movable portion 5 corresponds to the main body serving as a fixed portion. In addition, in such a case, the third winding portion and the fourth winding portion which are provided at the movable portion may be formed to be integral with each other. According to the drive apparatus 1 of the present embodiment, the first winding portion and the second winding portion of the main body 4 are arranged between the third winding portion and the fourth winding portion of the movable portion 5 in the a moving direction of the movable portion 5 (the lengthwise direction X). However, this disclosure is not limited to the above-described arrangement. The third winding portion and the fourth winding portion of the movable portion 5 may be arranged between the first winding portion and the second winding portion of the main body 4 in the moving direction of the movable portion 5 (the lengthwise direction X).

According to the aforementioned embodiment, the drive apparatus 1 for moving the backdoor (i.e., the operation portion) 102 of the vehicle 100 includes the main body 4, the movable portion 5 being movable relative to the main body 4, the first pulley (i.e., the first winding portion) 21, 21a, 21b and the second pulley (i.e., the second winding portion) 22a, 22b, 22c each provided at the main body 4, the third pulley (i.e., the third winding portion) 23a, 23b and the fourth pulley (i.e., the fourth winding portion) 24a, 24b each provided at the movable portion (5), the cable (i.e., the transmission member) 6 including the first cable portion (i.e., the first transmission portion) 6c wound around the first pulley 21, 21a, 21b and the third pulley 23a, 23b, and the second cable portion (i.e., the second transmission portion) 6d wound around the second pulley 22a, 22b, 22c and the fourth pulley 24a, 23b, the drum 7 and the motor 8 (i.e., the moving members) which move the cable 6) the drum 7 and the motor 8 pulling the first cable portion 6c and feeding out the second cable portion 6d, and thereby moving the movable portion 5 relative to the main body 4 in a manner that the movable portion 5 comes close to the main body 4, and the drum 7 and the motor 8 feeding out the first cable portion 6c and pulling the second cable portion 6d, and thereby moving the movable portion 5 relative to the main body 4 in a manner that the movable portion 5 moves away from the main body 4.

According to the above-described configuration, the drive apparatus 1 includes the simple configuration using the cable 6 and may be reduced in size.

According to the aforementioned embodiment, the main body 4 is configured to be inserted in the movable portion 5, the movable portion 5 is configured to reciprocate linearly relative to the main body 4, the drum 7 and the motor 8 pull the first cable portion 6c of the cable 6 and feed out the second cable portion 6d of the cable 6, and thereby move the movable portion 5 in a manner that the main body 4 is inserted into the movable portion 5, and the drum 7 and the motor 8 feed out the first cable portion 6c and pull the second cable portion 6d, and thereby move the movable portion 5 in a manner that the movable portion 5 protrudes from the main body 4.

According to the aforementioned embodiment, the drum 7 and the motor 8 pull the first cable portion 6c of the cable 6 in the direction B (i.e., the first direction), and the drum 7 and the motor 8 pull the second cable portion 6d of the cable 6 in the direction A (i.e., the second direction), and the direction B and the direction A are same as each other.

According to the aforementioned embodiment, the cable 6 corresponds to the single cable 6.

According to the above-described configuration, the drive apparatus 1 includes the simple configuration.

According to the aforementioned embodiment, the first pulley 21, 21a, 21b (i.e., the first winding portion), the second pulley 22a, 22b (i.e., the second winding portion), the third pulley 23a, 23b (i.e., the third winding portion) and the fourth pulley 24a, 24b (i.e., the fourth winding portion) are arranged linearly with one another in the lengthwise direction X of the drive apparatus 1.

According to the above-described configuration, the drive apparatus 1 can be formed to be narrow. Consequently, the drive apparatus 1 may be reduced in size.

According to the aforementioned embodiment, the drum 7 and the motor 8 are provided within the main body 4 or the fixed to the main body 4.

According to the above-described configuration, the drive apparatus 1 may be attached to the vehicle body 101 of the vehicle 100 easily.

According to the aforementioned embodiment, the first cable portion 6c of the cable 6 is wound around the third pulley 23a, 23b for plural times and the second cable portion 6d of the cable 6 is wound around the fourth pulley 24a, 24b for plural times.

According to the aforementioned embodiment, each of the first pulley 21, 21a, 21b, the second pulley 22a, 22b, 22c, the third pulley 23a, 23b and the fourth pulley 24a, 24b corresponds to the support body including the pulley 21, 21a, 21b, 22a, 22b, 22c, 23a, 23b, 24a, 24b, the shaft 11, 12, 13, 14, 41, the rotational body 40 or the cable guide groove 33, 43a, 43b.

According to the aforementioned embodiment, the third pulley 23a, 23b (i.e., the third winding portion) and the fourth pulley 24a, 24b (i.e., the fourth winding portion) are arranged between the first pulley 21, 21a, 21b (i.e., the first winding portion) and the second pulley 22a, 22b, 22c (i.e., the second winding portion) in the moving direction of the movable portion 5.

According to the aforementioned embodiment, the first pulley 21, 21a, 21b and the second pulley 22a, 22b, 22c are formed to be integral with each other.

According to the above-described configuration, the number of parts and components of the drive apparatus 1 may be reduced. Consequently, the drive apparatus 1 includes the simple configuration and may be reduced in size.

According to the aforementioned embodiment, the third pulley 23a, 23b and the fourth pulley 24a, 24b are formed to be integral with each other.

According to the above-described configuration, the number of parts and components of the drive apparatus 1 may be reduced. Consequently, the drive apparatus 1 includes the simple configuration and may be reduced in size.

According to the aforementioned embodiment, the first cable portion 6c of the cable 6 includes the first end portion 63 fixed to the first pulley 21 or to the third pulley 23a, and the second cable portion 6d of the cable 6 includes the second end portion 6b fixed to the second pulley 22b or to the fourth pulley 24b.

According to the aforementioned embodiment, the first cable portion 6c of the cable 6 includes the first end portion 6a fixed to the main body 4 or to the movable portion 5, and the second cable portion 6d of the cable 6 includes the second end portion 6b fixed to the main body 4 or to the movable portion 5.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A drive apparatus for moving an operation portion of a vehicle, the drive apparatus comprising:
a main body;
a movable portion being movable relative to the main body;
a first winding portion and a second winding portion each provided at the main body;
a third winding portion and a fourth winding portion each provided at the movable portion;
a transmission member including a first transmission portion wound around the first winding portion and the third winding portion, and a second transmission portion wound around the second winding portion and the fourth winding portion;
a moving member moving the transmission member;
the moving member pulling the first transmission portion and feeding out the second transmission portion, and thereby moving the movable portion relative to the main body in a manner that the movable portion comes close to the main body; and
the moving member feeding out the first transmission portion and pulling the second transmission portion, and thereby moving the movable portion relative to the main body in a manner that the movable portion moves away from the main body.

2. The drive apparatus according to claim 1, wherein
the main body is configured to be inserted in the movable portion,
the movable portion is configured to reciprocate linearly relative to the main body,
the moving member pulls the first transmission portion of the transmission member and feeds out the second transmission portion of the transmission member, and thereby moves the movable portion in a manner that the main body is inserted into the movable portion, and
the moving member feeds out the first transmission portion and pulls the second transmission portion, and thereby moves the movable portion in a manner that the movable portion protrudes from the main body.

3. The drive apparatus according to claim 1, wherein the moving member pulls the first transmission portion of the transmission member in a first direction and the moving member pulls the second transmission portion of the transmission member in a second direction, and the first direction and the second direction are same as each other.

4. The drive apparatus according to claim 1, wherein the transmission member corresponds to a single transmission member.

5. The drive apparatus according to claim 1, wherein the first winding portion, the second winding portion, the third winding portion and the fourth winding portion are arranged linearly with one another in a lengthwise direction of the drive apparatus.

6. The drive apparatus according to claim 1, wherein the moving member is provided within the main body or is fixed to the main body.

7. The drive apparatus according to claim 1, wherein the first transmission portion of the transmission member is wound around the third winding portion for a plurality of times and the second transmission portion of the transmission member is wound around the fourth winding portion for a plurality of times.

8. The drive apparatus according to claim 1, wherein each of the first winding portion, the second winding portion, the third winding portion and the fourth winding portion corresponds to a support body including a pulley, a shaft, a rotational body or a guide groove.

9. The drive apparatus according to claim 1, wherein the third winding portion and the fourth winding portion are arranged between the first winding portion and the second winding portion in a moving direction of the movable portion.

10. The drive apparatus according to claim 1, wherein the first winding portion and the second winding portion are formed to be integral with each other.

11. The drive apparatus according to claim 1, wherein the third winding portion and the fourth winding portion are formed to be integral with each other.

12. The drive apparatus according to claim 1, wherein
the first transmission portion of the transmission member includes a first end portion fixed to the first winding portion or to the third winding portion, and
the second transmission portion of the transmission member includes a second end portion fixed to the second winding portion or to the fourth winding portion.

13. The drive apparatus according to claim 1, wherein
the first transmission portion of the transmission member includes a first end portion fixed to the main body or to the movable portion, and
the second transmission portion of the transmission member includes a second end portion fixed to the main body or to the movable portion.
